(19) United States
(12) Patent Application Publication
(10) Pub. No.: US 2008/0276083 A1
(43) Pub. Date: Nov. 6, 2008

(54) Method for Transmitting a Message Containing a Description of an Action to be Executed in a Receiver Equipment

(75) Inventors: Bruno Tronel, Puteaux (FR); Louis Neau, Chateaugiron (FR); Pierre Fevrier, St Sulpice La Foret (FR)

Correspondence Address: PEARNE & GORDON LLP, 1801 EAST 9TH STREET, SUITE 1200, CLEVELAND, OH, 44114-3108, US

(73) Assignee: VIACCESS, LA DEFENSE CEDEX (FR)

(21) Appl. No.: 11/570,782

(22) PCT Filed: Jun. 29, 2005
(86) PCT No.: PCT/FR2005/050513

§ 371 Date: Dec. 18, 2006

(30) Foreign Application Priority Data
Jul. 1, 2004 (FR) 0451391

(51) Int. Cl. H04L 9/00

(52) U.S. Cl. 713/150

(57) ABSTRACT

The invention relates to a method for transmitting a message to a reception equipment by an operator, the message containing a description of an action to be executed in the said equipment at a time chosen by the operator.

This method comprises the following steps:
a—generate the said message as a function of the action to be executed,
b—completely or partially encrypt the said message using a secret parameter,
c—transmit the encrypted message to the said equipment,
d—store the encrypted message in the reception equipment, and,
e—at the time chosen by the operator, transmit a description for obtaining the said secret parameter to the reception equipment, and on reception,
f—decrypt the encrypted message memorised in the reception equipment using the said secret parameter,
g—process the said message so that the said action can be executed.

### TECHNICAL FIELD

The field of this invention is resistance against pirating of digital data distributed in scrambled form by an operator to users with access right.

More specifically, the invention relates to a method of transmitting a message to a reception equipment, the message containing a description of an action to be executed in the said equipment at a time chosen by the operator.

### STATE OF PRIOR ART

In a conventional conditional access control system, the operator sends two types of messages to reception equipment, firstly ECM (Entitlement Control Messages) containing conditions for access to scrambled data and control words CW encrypted by a secret key, and secondly EMM (Entitlement Management Messages) containing access rights for each user and/or the said secret key.

ECMs are transmitted with scrambled data while EMMs are usually transmitted before these data are distributed to users so that entitlements and the secret key can be registered in the security processor.

It has been observed that registering the secret key in the security processor some time before transmission of scrambled data can enable pirates to identify this key and fraudulently decrypt the control word CW.

To prevent this problem, document FR 2 835 670 published on Aug. 8, 2003 describes a method of late revelation of the same information Kc necessary for descrambling data transmitted to a group of receivers each provided with individual information SAi. This method is based on prior calculation of the information Kc as a function of the individual information SAi, a first parameter κ common to all receivers and a second parameter bi specific to each receiver. The second parameter bi is transmitted to receivers before the information Kc is required to descramble the data to calculate the value of the information Kc on reception, while the information K is only transmitted at the time at which Kc is to be used to descramble the data.

One disadvantage of this solution is due to the fact that it requires advanced calculation of the information Kc from preloaded elements and a recalculation of the data to be revealed by the receivers. Consequently, the use of this method requires the presence of a specific calculation software in each reception equipment.

The purpose of this invention is to overcome the disadvantages of prior art described above using a simple method in which late revelation of the relevant information depends on conventional processing done in receiver terminals.

Another purpose of the invention is to provide the operator with remote control over execution of this processing.

### PRESENTATION OF THE INVENTION

The invention recommends a method for executing an action in a reception equipment at a time chosen by the operator that cannot be predicted by frauders. For example, the action to be executed may be to write secret information in a security processor, to eliminate this information or to update this information.

More precisely, the invention proposes a method of transmitting a message to a reception equipment containing a description of the action to be executed comprising the following steps:

a—generate the said message as a function of the action to be executed,

b—completely or partially encrypt the said message using a secret parameter,

c—transmit the encrypted message to the said equipment,

d—store the encrypted message in the reception equipment, and

e—at the time chosen by the operator, transmit a description for obtaining the said secret parameter to the reception equipment, and on reception,

f—decrypt the encrypted message memorised in the reception equipment using the said secret parameter,

g—process the said message so that the said action can be executed.

According to the invention, the time chosen by the operator is delayed after step c).

According to the invention, the time at which the said secret parameter is obtained by the reception equipment determines the time at which the envisaged action is executed. Preferably, this secret parameter is a random variable transmitted to the reception equipment in an EMM message or an ECM message.

According to another characteristic of the invention, generation of the said secret parameter takes account of data characterising the current state of the reception equipment, these data possibly being:
a constant specific to this equipment, for example such as its address, or

data previously stored in this equipment and for which the value depends on use of this equipment, or

a combination of the previous data, possibly to which a random value has been added.

In this case, the description of the said secret parameter is transmitted to the reception equipment in an ECM message or an EMM message.

The equipment obtains the value of the secret parameter by interpreting this description.

Thus, when the action to be executed is to write a secret key in a smart card associated with the reception equipment, in a first example embodiment, this writing can only be done by a card referenced in the transmitted message.

In a second example embodiment, the writing can only be done by a card containing digital data calculated from access entitlements that the user has officially.

According to another preferred characteristic of the invention, the message containing the description of the action to be executed has an EMM message structure. In this case, the said message is sent to the reception equipment as general data encrypted in one or several EMM transport messages comprising a block of bits enabling the reception equipment to reconstitute the message containing the description of the action to be executed before the said message is decrypted.

The method according to the invention is used in a reception terminal comprising:

means of memorising a message containing a description of an action to be executed by the said terminal, the said message being previously transmitted to the terminal in encrypted form using a secret parameter,

means of decrypting the said message using the secret parameter at a time defined by a delay after reception of the said message,

means of processing the said decrypted message to execute the action in the receiving terminal.

In a first application of the method, the terminal is a decoder provided with a security processor composed of a smart card.

In a second application of the method, the terminal is a computer connected to a scrambled data server and comprising a conditional access module.

This conditional access module executes a computer program including:

instructions to memorise a message encrypted using a secret parameter and containing a description of an action to be executed,

instructions to decrypt the said message using the said secret parameter at a time defined by a delay after reception of the said message,

instructions to process the decrypted message to execute the described action.

### BRIEF DESCRIPTION OF THE DRAWINGS

Other characteristics and advantages of the invention will become clear after reading the following description given as a non limitative example with reference to the attached figures in which:

FIG. 1 diagrammatically shows the structure of a message carrying a secret decryption key,

FIG. 2 diagrammatically shows the structure of a message to write the message in FIG. 1 in a security processor,

FIG. 3 diagrammatically shows the two-part structure of a message to write the message in FIG. 1,

FIG. 4 diagrammatically shows the structure of an ECM message revealing a secret decryption key.

### DETAILED PRESENTATION OF PARTICULAR EMBODIMENTS

The following description relates to application of the method according to the invention in a system for transmission of audiovisual programs scrambled by a control word CW to a set of reception equipment, the control word CW being previously encrypted using a secret key K.

This system includes a central site arranged around an operator comprising:

means of generating a message containing a description of an action to be executed in one or several items of reception equipment in the said set of equipment,

means of completely or partially encrypting the said message by a secret parameter,

means of transmitting the encrypted message to each target reception equipment at time T1, and then of transmitting the description of the said secret parameter to this reception equipment at a time T2 chosen by the operator.

Each reception equipment comprises:

a non-volatile memory to store the encrypted message,

means of decrypting the encrypted message stored in the said non-volatile memory using the said secret parameter obtained at time T2, and

means of processing the said message to execute the said action.

Preferably, time T2 is defined by a delay from time T1.

The reception equipment consists of decoders each provided with a security processor, and the action to be executed consists of writing the secret key necessary to decrypt the control word CW in the security processor.

### Structure of a Confidential EMM Transporting the Key K

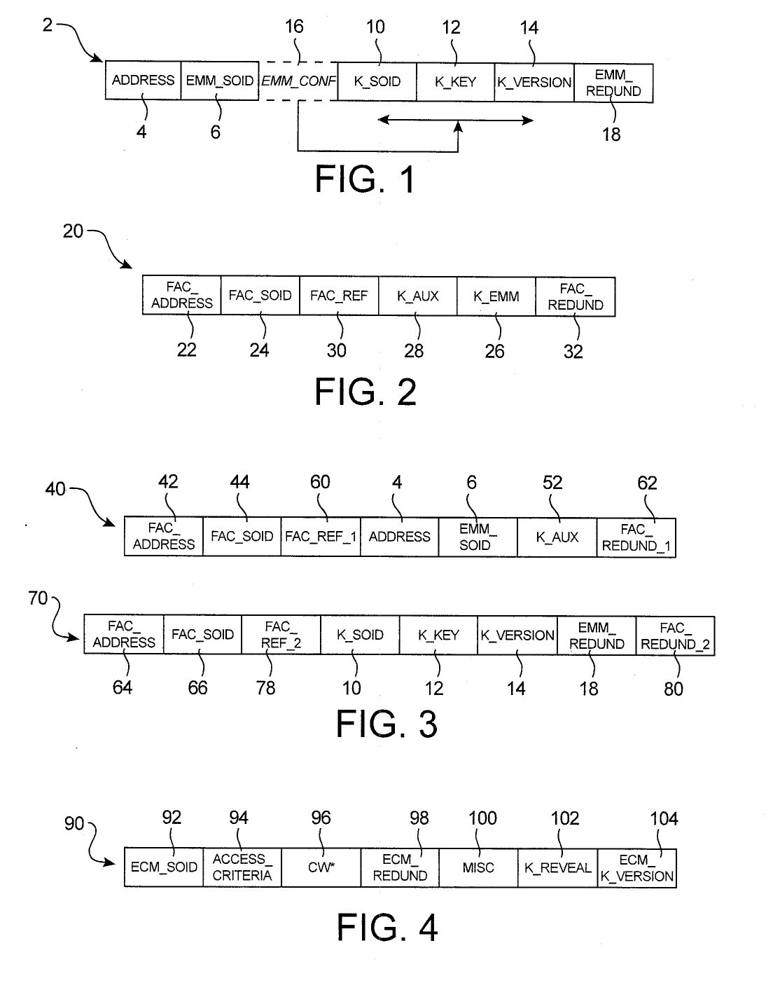

FIG. 1 diagrammatically shows the structure of a confidential EMM message 2 transporting the key K to a security processor associated with a decoder. This message comprises the following functional parameters:

ADDRESS 4: this field contains the address of the security processor to which the EMM message is intended. Note that this message may be sent to one decoder in the set of equipment, or to several decoders in the said set of equipment, or to all decoders in the said set of equipment. Some parts of the address may be made confidential by a special encryption.

EMM_SOID 6: this field is related to identification of the cryptographic context applied to the EMM message 2. The EMM_SOID parameter specifies the system of keys used in the cryptography applied to the EMM message 2, particularly the reference to the decryption key of the transported key K.

K_SOID 10: this field contains a parameter related to identification of the cryptographic context to which the transported key K is intended. In particular, this parameter specifies the reference under which this key K will be known in this context.

K_KEY 12: this field contains the cryptogram of the transported key K. This cryptogram depends on the cryptographic context of the EMM message 2 indicated by the EMM_SOID parameter 6.

K_VERSION 14: this optional field is related to the version number of the transported key K. When this parameter exists, the version number of the transported key K will be associated with the value of the key when it is written in the security processor. Depending on the envisaged implementation, this parameter may specify the reference of the data area in which the version number must be memorized. This parameter also specifies that the data area is either erased and then written, or replaced.

Note that this parameter identifies a data block FAC like that specified in standard UTE C90-007 and in which the version number will be memorised.

EMM_CONF 16: this field is optional and relates to the parameter settings of the confidentiality applied to parameters K_SOID 10, K_KEY 12 and K_VERSION 14. These parameters are encrypted during transport of the EMM 2, independently of whether or not the parameter EMM_CONF 16 is present, and are then decrypted by the security processor during processing of the EMM message 2 to cancel confidentiality.

When the EMM_CONF 16 parameter is present, it enables the security processor to cancel confidentiality and to process the message completely to obtain the key K. In this case, the key K is not revealed late.

When the EMM_CONF 16 parameter is absent, the operator transmits a reveal parameter K_REVEAL to the security processor in an ECM message and this parameter is associated with the EMM message 2 to cancel confidentiality and to obtain the key K. This K_REVEAL parameter is used to reconstitute the confidentiality parameter settings. In this case, as long as the K_REVEAL parameter is not known, the decoder cannot obtain the key K. It is then judicious to transmit the reveal parameter K_REVEAL in an ECM just at the time at which the security processor needs the key K. To achieve this, the EMM message is memorised in the security processor until reception of K_REVEAL.

EMM_REDUND 18: this field contains cryptographic redundancy information for the EMM message 2 transporting the key K.

In one variant embodiment of the method, the functional parameters above are combined using a T L V (Type Longueur Valeur) structure. These parameters may be in an order that depends on the selected implementation.

### Transmission of a Confidential EMM Containing a Key K

As already mentioned, the EMM message 2 containing the key K must be memorised in the security processor until the security processor receives the reveal parameter K_REVEAL that enables it to process this EMM message 2.

A first solution consists of storing the message to be processed in a particular area of the terminal as long as the security processor does not have all information necessary to process this message. A second solution consists of storing the message to be processed in a particular area of the security processor that can be removed from the reception equipment, in this case the EMM message is memorized in the security processor so that it can obtain the key K even if the security processor is associated with another terminal.

In one preferred embodiment, the EMM message 2 containing the key K is transmitted to the decoder as general data in one or several EMM transport messages. One example of such data is a data block FAC as specified in UTE standard C90-007.

In a first variant embodiment, the EMM 2 is transported in a single EMM transport message.

In a second variant embodiment, the EMM 2 is transported in several EMM transport messages.

FIG. 2 diagrammatically shows the structure of an EMM transport message 20. This message comprises the following functional parameters:

FAC_ADDRESS 22: this parameter represents the address of the security processor to which the EMM transport message 20 is intended. This message may be intended for one security processor, several security processors in a group, or all security processors in this group. Some parts of the address may be made confidential by a special encryption.

FAC_SOID 24: this parameter relates to identification of the cryptographic context applied to the EMM transport message 20 and in particular specifies the system of keys used in the cryptography applied to this message.

K_EMM 26: this parameter is the EMM message 2 shown in FIG. 1 as general data for the EMM transport message 20. Note that in this case, the EMM message 2 does not include the EMM_CONF 16 parameter.

K_AUX 28: this parameter contains data that will facilitate delayed processing of message K_EMM 26, such as a reminder of the reference of the context to which the key K is intended, or the version of the key K.

FAC_REF 30: this parameter represents a reference of the data area in which the parameters K_EMM 26 and K_AUX 28 are to be memorized. This reference may be absolute in the memory space of the security processor, or relative to the cryptographic context FAC_SOID 24.

Note that the FAC_REF 30 parameter may also specify that the data area is either erased and then written, or replaced.

In one particular embodiment, the K_EMM 26 and K_AUX 28 parameters that are data to be written in the data area may be syntactically included in the FAC_REF 30 parameter.

FAC_REDUND 32: this parameter concerns the cryptographic redundancy of the EMM transport message 20.

In another embodiment, the EMM 2 containing the key K is split into two parts transported independently of each other, in a first transport message EMMa 40, and in a second transport message EMMb 70. These two parts are then memorised separately from each other in the security processor. This embodiment is suitable for the case in which the size of a data memory block or the size of an EMM is limited.

FIG. 3 diagrammatically shows the structure of the EMMa message 40 and the structure of the EMMb message 70. The EMMa message 40 transports at least the ADDRESS 4 parameter and the EMM_SOID 6 parameter of the EMM 2. The EMMb message 70 transports the K_SOID 10, K_KEY 12, K_VERSION 14 and EMM_REDUND 18 parameters of this EMM 2. Note that in this case, the EMM message 2 does not include the EMM_CONF 16 parameter.

The first transport message EMMa 40 contains the following functional parameters:

FAC_ADDRESS 42: this parameter represents the address of the security processor to which the EMMa transport message 40 is addressed. This message may be intended for one security processor, several security processors in a group of security processors, or to all security processors in this group. Some parts of the address may be made confidential by a special encryption.

FAC_SOID 44: this parameter relates to identification of the cryptographic context applied to the transport message EMMa 40 and in particular specifies the keys system used in the cryptography applied to this message.

The ADDRESS 4 and EMM_SOID 6 parameters are identical to those in the EMM 2 in FIG. 1.

K_AUX 52: this parameter contains data intended to facilitate reconstitution or delayed processing of the EMM2, such as a reminder of the version of the key K. This parameter K_AUX 52 depends on the implementation.

FAC_REF_1 60: this parameter represents a reference to the data area in which the ADDRESS 4, EMM_SOID 6, K_AUX 52 parameters are to be memorized. This reference may be absolute in the memory space of the security processor or relative to the cryptographic context FAC_SOID 44.

Note that the FAC_REF_1 60 parameter may also specify that the data area is either erased and then written, or replaced.

The ADDRESS 4, EMM_SOID 6 and K_AUX 52 parameters that form the data to be written in the data area may be syntactically included in the FAC_REF_1 60 parameter,

FAC_REDUND_1 62: represents the cryptographic redundancy of the EMMa transport message 40.

The second EMMb transport message 70 contains the following functional parameters:

FAC_ADDRESS 64: this parameter represents the address of the security processor. It is identical to the FAC_ADDRESS 42 parameter in the EMMa transport message 40.

FAC_SOID 66: relates to identification of the cryptographic context applied to the EMMb transport message 70. It is identical to the FAC_SOID 44 parameter in the EMMa transport message 40.

The K_SOID 10, K_KEY 12, K_VERSION 14, EMM_REDUND 18 parameters have been previously described for the EMM message 2.

FAC_REF_2 78: this parameter represents a reference of the data area in which the K_SOID 10, K_KEY 12, K_VERSION 14 and EMM_REDUND 18 parameters must be memorized. This reference may be absolute in the memory space of the security processor or it may be relative to the FAC_SOID 66 cryptographic context.

Note that the FAC_REF_2 78 parameter may also specify that the data area is either erased and then written, or replaced, and that the data to be written in the data area may be syntactically included in the FAC_REF_2 78 parameter.

FAC_REDUND_2 80: represents cryptographic redundancy of the EMMb transport message 70.

In all transport modes of the EMM message 2, a preferred implementation of the functional parameters given above is the combination of these parameters using the T L V (Type Longueur Valeur) structure. These parameters may be in an order that depends on the selected implementation.

### Structure of an ECM Revealing the Decryption Key

FIG. 4 diagrammatically shows an ECM message 90 transporting control words to be decrypted by a late revealed key K.

This message comprises the following functional parameters:

ECM_SOID 92: this parameter represents an identification of the cryptographic context applied to the ECM message 90. This parameter specifies the keys system used in the cryptography applied to this message, and particularly the reference of the decryption key K of the control words.

ACCESS_CRITERIA 94: this parameter represents a list of conditions for access to scrambled data.

CW* 96: this parameter represents a cryptogram of the control word CW transported in the ECM message 90.

ECM_REDUND 98: this parameter represents a cryptographic redundancy of the ECM message 90 related to the ACCESS_CRITERIA 94 and CW* 96 fields.

MISC 100: this optional parameter represents auxiliary data characterising coding of the ECM message 90.

K_REVEAL 102: parameter revealing the decryption key K. This parameter reconstitutes the EMM_CONF 16 parameter controlling confidentiality of the EMM message 2 transporting the key K.

ECM_K_VERSION 104: this optional parameter represents a version of the decryption key K.

In one preferred embodiment of the method, these functional parameters are combined using a T L V (Type Longueur Valeur) structure. These parameters may be in an order that depends on the selected implementation.

The ECM_SOID 92, ACCESS_CRITERIA 94, CW* 96 and ECM_REDUND 98 parameters and optionally the MISC 100 parameter are sufficient in an ECM message in which the control words are decrypted by a predefined key that does not need to be revealed.

The K_REVEAL 102 parameter and optionally the ECM_K_VERSION 104 parameter are present when the decryption key K is revealed late.

During operation, the K_REVEAL 102 parameter is extracted from the ECM to decrypt the EMM 2 transporting the key K, and reveal the decryption key K.

When it is memorised in the security processor in two parts, the EMM 2 transporting the key K is reconstituted by the security processor and then decrypted using the K_REVEAL 102 parameter to cancel confidentiality.

The EMM 2 thus decrypted is then processed to decrypt the key K.

In a first variant embodiment, the decryption key K thus obtained is not stored in the security processor after it has been revealed. It is revealed to each ECM to decrypt the control words. In this case, the EMM 2 does not contain a K_VERSION 14 parameter and the ECM 90 does not contain a ECM_K_VERSION 104 functional parameter.

In a second variant embodiment, the decryption key K obtained is stored in the security processor after it has been revealed for the first time with its version number K_VERSION 14 provided by the EMM 2. In this case, the ECM 90 comprises the additional ECM_K_VERSION 104 parameter identifying the version of the current decryption key K. As long as the ECM 90 identifies the same version of the decryption key K as the decryption key already stored, in other words as long as the decryption key K is not changed, the security processor does not reveal it. If the ECM 90 references a version of the decryption key K that is different from the version already stored, the security processor reveals the decryption key K again and stores its new value and its new version number. Revealing is also done when the key K does not exist in the terminal part, regardless of whether it has not yet been stored or has been deleted.

In this second variant embodiment, the decryption key K may be stored in the security processor for a period, for example limited by a number of control words decryptions made with this key K. At the end of such a period, the key K is automatically deleted. The limit of such a period may be defined as a constant in the security processor or it may be done by a specific data transmitted to the security processor in an EMM.

1. Method of transmitting a message to a reception equipment by an operator, the message containing a description of an action to be executed in the said equipment at a time chosen by the operator, characterised in that it comprises the following steps:
a—generate the said message as a function of the action to be executed,
b—completely or partially encrypt the said message using a secret parameter,
c—transmit the encrypted message to the said equipment,
d—store the encrypted message in the reception equipment, and,
e—at the time chosen by the operator, transmit a description for obtaining the said secret parameter to the reception equipment,
and on reception,
f—decrypt the encrypted message memorised in the reception equipment using the said secret parameter,
g—process the said message so that the said action can be executed.

2. Method according to claim 1, characterised in that the time chosen by the operator is delayed after step c).

3. Method according to claim 1, characterised in that the time at which the said secret parameter is obtained by the reception equipment determines the time at which the envisaged action is executed.

4. Method according to claim 1, characterised in that the description of the secret parameter is transmitted to the reception equipment in an EMM message.

5. Method according to claim 1, characterised in that the description of the secret parameter is transmitted to the terminal in an ECM message.

6. Method according to claim 1, characterised in that the said secret parameter is a random variable.

7. Method according to claim 1, characterised in that generation of the said secret parameter takes account of data characterising the current state of the reception equipment.

8. Method according to claim 1, characterised in that the said message containing the description of the action to be executed has an EMM message structure.

9. Method according to claim 1, characterised in that the said message containing the description of the action to be executed is sent to the reception equipment as general data encrypted in one or several EMM transport messages.

10. Method according to claim 9, characterised in that the said EMM transport messages comprise a block of bits enabling the reception equipment to reconstitute the message containing the description of the action to be executed before the said message is decrypted.

11. Method according to claim 1, characterised in that the said action to be executed in the equipment is to write at least one secret key.

12. Method according to claim 11, characterised in that the message containing the description of the secret key write also comprises a parameter representing a version of the secret key to be written.

13. Method according to claim 11, characterised in that the said secret key to be written is intended for decrypting a control word enabling access to scrambled data sent to the reception equipment.

14. Method according to claim 13, characterised in that the said scrambled data represent audiovisual programs.

15. Reception terminal, characterised in that it comprises:
means of memorising a message containing a description of an action to be executed by the said terminal, the said message being previously transmitted to the said receiver terminal by an operator in encrypted form using a secret parameter,
means of decrypting the said message using the said secret parameter at a time chosen by the operator,
means of processing the said decrypted message to execute the action in the receiving terminal.

16. Terminal according to claim 15, characterised in that it comprises a decoder provided with a security processor.

17. Terminal according to claim 16, characterised in that the security processor is a smart card.

18. Terminal according to claim 15, characterised in that it comprises a computer connected to a scrambled data server and comprising a conditional access module.

19. Computer program that can be run in a receiving terminal and intended to cooperate with a security processor to control access to digital data distributed by an operator, characterised in that it comprises:
instructions to memorise a message containing a description of an action to be executed by the said receiving terminal, the said message being previously encrypted using a secret parameter and sent to the said receiving terminal,
instructions to decrypt the said message using the said secret parameter at a time defined by the operator,
instructions to process the decrypted message to execute the described action.

20. System for sending digital scrambled data, comprising a central site arranged at an operator and a set of installed reception equipment, characterised in that the central site comprises:
a—means for generating a message containing a description of an action to be executed in a reception equipment;
b—means for completely or partially encrypting the said message using a secret parameter;
c—means for transmitting the encrypted message to the said reception equipment at a time T1, and for transmitting the description of the said secret parameter to the reception equipment at a time T2 chosen by the operator;
and in that each reception equipment comprises:
d—a non-volatile memory to store the encrypted message,
e—means of decrypting the encrypted message stored in the said non-volatile memory using the said secret parameter obtained at time T2, and
g—means of processing the said message to execute the said action.

21. Système according to claim 20 in which the time T2 is delayed from time T1.

22. Système according to claim 20, in which the time for the reception equipment to obtain the said secret parameter transmitted at time T2 determines the time for processing the encrypted messaged transmitted at time T1 in the reception equipment.

23. Système according to claim 20, in which the reception equipment comprises a decoder and a security processor.

24. Système according to claim 20, in which the reception equipment comprises a computer fitted with a security processor.

25. System according to one of claims 23 or 24, characterised in that the security processor is a smartcard.
